(19) United States
(12) Patent Application Publication
(10) Pub. No.: US 2015/0212004 A1
(43) Pub. Date: Jul. 30, 2015

(54) ELECTRIC FIELD ENHANCEMENT ELEMENT, RAMAN SPECTROSCOPIC METHOD, RAMAN SPECTROSCOPIC DEVICE, AND ELECTRONIC APPARATUS

(71) Applicant: Seiko Epson Corporation, Tokyo (JP)

(72) Inventor: Tetsuo MANO, Chino (JP)

(21) Appl. No.: 14/605,400

(22) Filed: Jan. 26, 2015

(30) Foreign Application Priority Data
Jan. 27, 2014 (JP) 2014-012126

(51) Int. Cl. G01N 21/65; G01N 21/03; G01J 3/44

(52) U.S. Cl. CPC G01N 21/658; G01J 3/4412; G01N 21/0303; G01N 2201/06113

(57) ABSTRACT

An electric field enhancement element includes a metal fine structure layer configured including a metal fine structure smaller in size than a wavelength of incident light, a mirror layer adapted to reflect light having passed through the metal fine structure layer, a magnetooptic material layer disposed between the metal fine structure layer and the mirror layer, and adapted to cause at least one of a Faraday effect and a Cotton-Mouton effect, and a magnetic field generation device adapted to apply a magnetic field to the magnetooptic material layer.

### BACKGROUND

1. Technical Field

The present invention relates to an electric field enhancement element a Raman spectroscopic method, a Raman spectroscopic device, and an electronic apparatus.

2. Related Art

In recent years, the substance sensing technology has been increased in demand in medical diagnosis, food inspection, and so on, and in particular, development of the sensing technology small in size and high in speed has been demanded. A variety of types of sensors (electric field enhancement elements) including sensors using an electrochemical method are studied, and sensors using the surface plasmon resonance (SPR) have drawn increasing attention on the grounds of a possibility of integration, low cost, and tolerance for a measurement environment. For example, it has been performed to sense the presence of a detection target molecule using the SPR generated in a metal thin film disposed on a surface of a total reflection prism, namely by detecting a shift in the SPR occurring between before and after the adsorption of the detection target molecule such as presence or absence of the adsorption of an antigen in an antigen-antibody reaction.

Further, as one of the highly sensitive spectroscopic technologies for detecting low-concentration molecules, surface enhanced Raman Scattering (SERS) using the SPR has attracted attention. The SERS denotes a phenomenon that the Raman scattering light is enhanced 10² through 10¹⁴ times on a metal surface (a metal nanoparticle surface) having nanometer scale convexoconcave structures. When irradiating the molecules with a single-wavelength excitation light such as a laser beam, the light (Raman scattering light) having a wavelength shifted from the wavelength of the excitation light as much as a wavelength corresponding to the vibration energy of the molecule is scattered. By performing a spectroscopic process on the scattering light, a spectrum (fingerprint spectrum) specific to the molecular species can be obtained. Although the fingerprint spectrum is generally weak, by using the SERS, it becomes possible to analyze the shape of the spectrum at high sensitivity to identify the target molecule.

In, for example, JP-T-2007-538264, there is described the fact that in a sensor including a dielectric spacer layer formed on a plasmon resonance mirror layer, and a nanoparticle layer formed on the dielectric spacer layer, a plasmon resonance response can be adjusted by adjusting parameters such as the distance between the layers, and the size and the shape of the nanoparticle.

When the target substance (the target molecule) adsorbs to a surface of the metal nanoparticles, the refractive index in the periphery of the metal nanoparticle varies, and thus, the plasmon resonance wavelength also varies. The variation of the plasmon resonance wavelength depends on the type and the amount of the target substance. However, in the method of manufacturing the sensor (the electric field enhancement element) with the distance between the layers and the size and so on of the nanoparticle changed in accordance with the plasmon resonance wavelength, it is necessary to manufacture the sensor for each of the types and amounts of the target substance. Therefore, it has not been easy to deal with the variation in the plasmon resonance wavelength.

### SUMMARY

An advantage of some aspects of the invention is to provide an electric field enhancement element capable of dealing with the variation in plasmon resonance wavelength. Further, another advantage of some aspects of the invention is to provide a Raman spectroscopic method using the electric field enhancement element described above. Another advantage of some aspects of the invention is to provide a Raman spectroscopic device including the electric field enhancement element described above. Still another advantage of some aspects of the invention is to provide an electronic apparatus including the Raman spectroscopic device described above.

The invention can be implemented as the following aspects or application examples.

An electric field enhancement element according to an aspect of the invention includes a metal fine structure layer configured including a metal fine structure smaller in size than a wavelength of incident light, a mirror layer adapted to reflect light having passed through the metal fine structure layer, a magnetooptic material layer disposed between the metal fine structure layer and the mirror layer, and adapted to cause at least one of a Faraday effect and a Cotton-Mouton effect, and a magnetic field generation device adapted to apply a magnetic field to the magnetooptic material layer.

In such an electric field enhancement element, by applying a magnetic field to the magnetooptic material layer using the magnetic field generation device, it is possible to vary the refractive index of the magnetooptic material layer to thereby vary the length of a light path between the metal fine structure layer and the mirror layer in which the light having passed through the metal fine structure layer proceeds. Thus, even if the sample including the target substance is introduced, and then the target substance adsorbs to the metal fine structure to cause the shift of the plasmon resonance wavelength, the light path length can be compensated in accordance with the shift of the plasmon resonance wavelength. Therefore, the electric field enhancement element can easily deal with the variation in the plasmon resonance wavelength without manufacturing the element for each of the types and the amounts of the target substance.

In the electric field enhancement element according to the aspect of the invention, the magnetic field generation device may include a coil.

According to such an electric field enhancement element, the magnetic field to be applied to the magnetooptic material layer can easily be controlled.

In the electric field enhancement element according to the aspect of the invention, the magnetic field generation device may include a permanent magnet.

According to such an electric field enhancement element, the magnetic field to be applied to the magnetooptic material layer can easily be controlled.

In the electric field enhancement element according to the aspect of the invention, the electric field enhancement element may further include a flow channel adapted to allow a sample including a target substance to have contact with the metal fine structure layer.

According to such an electric field enhancement element, even if the refractive index of the space (flow channel) between the metal fine structure layer and the magnetooptic material layer has varied, the light path length between the metal fine structure layer and the mirror layer can be adjusted to an optimum value (e.g., the value with which the intensity of the Raman scattering light becomes the maximum).

In the electric field enhancement element according to the aspect of the invention, an application direction of a magnetic field to the magnetooptic material layer may be one of a direction identical to an incident direction of the light to the magnetooptic material layer and a direction perpendicular to the incident direction.

In such an electric field enhancement element, since the Faraday geometry or the Voigt geometry is provided, the light path length of the light passing through the magnetooptic material layer can more efficiently be varied.

In the electric field enhancement element according to the aspect of the invention, the magnetooptic material layer may have a garnet type crystal structure, and may be expressed by a composition formula of R₃₋ₓBiₓFe_{5-y}A_{y}O₁₂.

In the composition formula, R represents at least one element selected from scandium (Sc), yttrium (Y), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu), Bi represents bismuth, Fe represents iron, A represents at least one element selected from gallium (Ga) and aluminum (Al), O represents oxygen, and x and y exist within the ranges of 0≦x<3 and 0≦y<5, respectively.

In such an electric field enhancement element, the magnetooptic material layer has high permeability to the incident light (e.g., light with a wavelength of 633 nm), and can further obtain a significant variation in refractive index with respect to the applied magnetic field.

A Raman spectroscopic method according to another aspect of the invention is adapted to analyze a target substance and includes making the target substance adsorb to the metal fine structure layer of the electric field enhancement element according to the aspect of the invention described above, applying a magnetic field to the magnetooptic material layer, then applying the incident light from the metal fine structure layer side to detect light reflected by the electric field enhancement element, and then determining the magnetic field, with which reflectance in the electric field enhancement element becomes a local minimum, and analyzing the target substance based on the light detected in a state of applying the magnetic field, with which the reflectance becomes the local minimum, to the magnetooptic material layer.

In such a Raman spectroscopic method, since the electric field enhancement element according to the aspect of the invention is used, the light path length between the metal fine structure layer and the mirror layer can be varied, and thus, it is possible to easily deal with the variation in the plasmon resonance wavelength due to the adsorption of the target substance.

A Raman spectroscopic device according to still another aspect of the invention is adapted to analyze a target substance and includes the electric field enhancement element according the aspect of the invention described above, alight source adapted to irradiate the metal fine structure layer having the target substance adsorbed with the incident light, and a photodetector adapted to detect light reflected by the electric field enhancement element.

According to such a Raman spectroscopic device, since the electric field enhancement element according to the aspect of the invention is included, it is possible to easily deal with the variation in the plasmon resonance wavelength due to the adsorption of the target substance.

An electronic apparatus according to yet another aspect of the invention includes the Raman spectroscopic device according to the aspect of the invention described above, an operation section adapted to perform an operation on health medical information based on detection information from the photodetector, a storage section adapted to store the health medical information, and a display section adapted to display the health medical information.

According to such an electronic apparatus, since the Raman spectroscopic device according to the aspect of the invention is included, the detection of a trace substance can easily be achieved, and thus, the accurate health medical information can be provided.

In the electronic apparatus according to the aspect of the invention, the health medical information may include information related to presence or absence, or an amount of at least one biologically-relevant substance selected from bacteria, a virus, a protein, a nucleic acid, and an antigen/antibody, or at least one compound selected from an inorganic molecule and an organic molecule.

According to such an electronic apparatus, since the Raman spectroscopic device according to the aspect of the invention is included, the detection of a trace substance can easily be achieved, and thus, the accurate health medical information can be provided.

### BRIEF DESCRIPTION OF THE DRAWINGS

The invention will be described with reference to the accompanying drawings, wherein like numbers reference like elements.

FIG. 1 is a schematic diagram of a cross-section of an essential part of an electric field enhancement element according to an embodiment of the invention.

FIG. 2 is a schematic diagram of a cross-section of an essential part of the electric field enhancement element according to the embodiment.

FIG. 3 is a schematic diagram of a cross-section of an essential part of the electric field enhancement element according to the embodiment.

FIG. 4 is a schematic diagram of a cross-section of an essential part of the electric field enhancement element according to the embodiment.

FIG. 5 is a cross-sectional view schematically showing a GSP structure.

FIG. 6 is a cross-sectional view schematically showing the GSP structure.

FIG. 7 is a graph showing a relationship between the wavelength and the reflectance.

FIG. 8 is a flowchart for explaining a Raman spectroscopic method according to the present embodiment.

FIG. 9 is a graph showing a relationship between the wavelength and the reflectance.

FIG. 10 is a plan view schematically showing a Raman spectroscopic device according to the embodiment.

FIG. 11 is a diagram schematically showing an electronic apparatus according to the embodiment.

### DESCRIPTION OF EXEMPLARY EMBODIMENTS

Hereinafter, some embodiments of the invention will be explained. The embodiments explained hereinafter are each for explaining an example of the invention. The invention is not at all limited to the embodiments described below, and includes a variety of types of modified configurations to be put into practice within the scope or the spirit of the invention. It should be noted that all of the constituents explained hereinafter are not necessarily essential elements of the invention.

### 1. Electric Field Enhancement Element

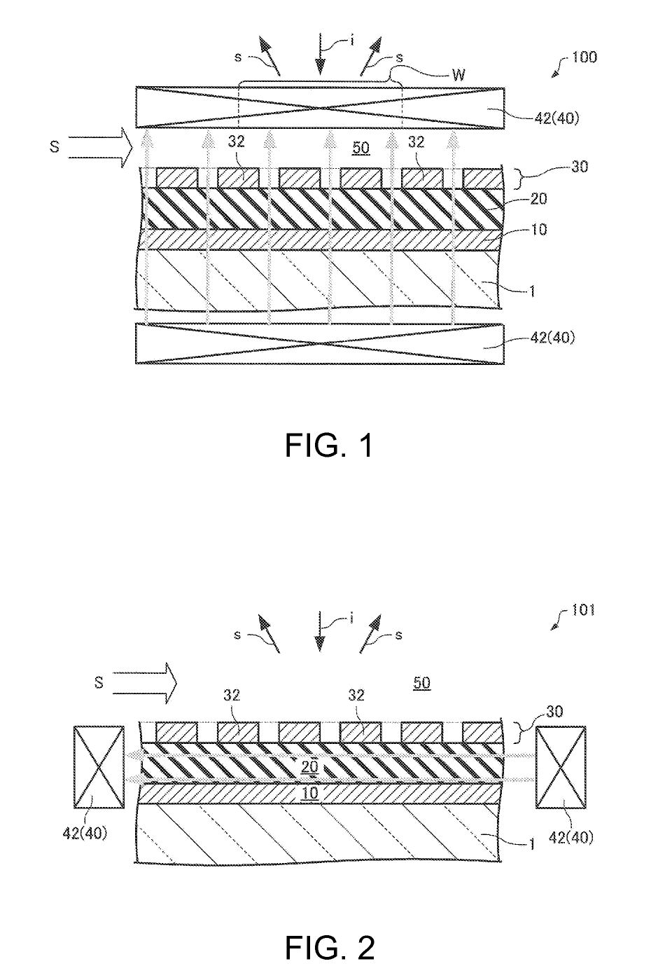

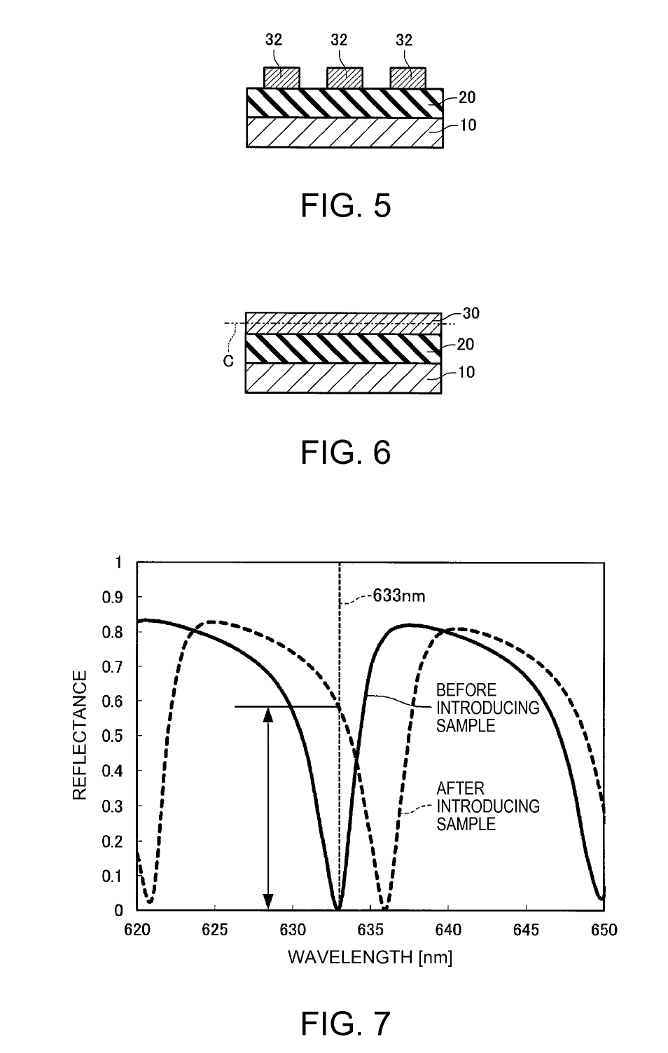

An electric field enhancement element according to the present embodiment will be explained with reference to the accompanying drawings. FIG. 1 is a schematic diagram of a cross-section of an essential part of the electric field enhancement element 100 according to the present embodiment. FIGS. 2 through 4 are schematic diagrams of cross-sections of essential parts of the electric field enhancement elements 101 through 103 according to the embodiments, respectively. FIGS. 5 and 6 are cross-sectional views schematically showing a gap type surface plasmon (GSP) structure.

As shown in FIG. 1, the electric field enhancement element 100 includes a mirror layer 10, a magnetooptic material layer 20, a metal fine structure layer 30, and a magnetic field generation device 40.

### 1.1. Mirror Layer

The electric field enhancement element 100 according to the present embodiment includes the mirror layer 10. The mirror layer 10 is not particularly limited as long as the mirror layer 10 provides a surface of reflecting light, and can have a shape of, for example, a film, a plate, a layer, or a membrane. The mirror layer 10 can be formed of a dielectric mirror having arbitrary dielectric bodies stacked on each other.

The mirror layer 10 is disposed so as to be opposed to the metal fine structure layer 30. The mirror layer 10 can also be disposed so as to be parallel to the metal fine structure layer 30. The mirror layer 10 is capable of reflecting the incident light i having passed through the metal fine structure layer 30.

The mirror layer 10 can also be disposed above, for example, a substrate 1. The substrate 1 in this case is not particularly limited, but in the case in which a propagating surface plasmon (PSP) is excited in the mirror layer 10, one difficult to affect the PSP is preferable. As the substrate 1, there can be cited, for example, a glass substrate, a quartz substrate, a silicon substrate, and a resin substrate. By adopting a material, which has permeability to the magnetic field generated by the magnetic field generation device 40, as the substrate 1, a degree of freedom of arrangement of the magnetic field generation device 40 can be raised.

The shape of the surface of the substrate 1 on which the mirror layer 10 is disposed is not particularly limited. In the case of forming a predetermined structure on the surface of the mirror layer 10, it is possible to provide a surface corresponding to the predetermined structure. Further, in the case of making the surface of the mirror layer 10 flat, it is possible to make the surface of the corresponding part flat. In the example shown in FIG. 1, the mirror layer 10 shaped like a layer is disposed above the substrate 1.

In the present specification, the thickness direction of the mirror layer 10 is referred to as a thickness direction, a height direction, and so on in some cases. In the present embodiment, the thickness direction of the mirror layer 10 coincides with the thickness direction of the metal fine structure layer 30 described later. Further, in the case in which the mirror layer 10 is disposed on the surface of the substrate 1, the normal direction of the surface of the substrate 1 is referred to as the thickness direction or the height direction in some cases. Further, in some cases, a direction toward the mirror layer 10 viewed from the substrate 1 is expressed as top or upside, and the opposite direction is expressed as bottom or downside. Such expressions of upside, downside are used independently of the direction in which the gravity acts, and are assumed to be expressed arbitrarily setting the viewpoint and the direction of the gaze in the case of viewing the element. Further, in the present specification, the expression of, for example, “a member B is disposed above a member A” has a meaning including the case in which the member B is disposed so as to have contact with an upper surface of the member A, and the case in which the member B is disposed above the member A via another member or a space.

The mirror layer 10 can be formed by a process such as a vapor deposition process, a sputtering process, a casting process, or a machining process. In the case in which the mirror layer 10 is disposed above the substrate 1 as a thin film, it is also possible to dispose the mirror layer above the entire surface of the substrate 1, or above a part of the substrate 1. The thickness of the mirror layer 10 is not particularly limited, and can be set to be, for example, no smaller than 10 nm and no larger than 1 mm, preferably no smaller than 20 nm and no larger than 100 μm, and more preferably no smaller than 30 nm and no larger than 1 μm.

The mirror layer 10 is more preferably formed of metal in which there can exist an electric field where an electric field provided by the incident light i and polarization induced by the electric field vibrate in respective phases opposite to each other, namely metal in which the real part of the dielectric function can have a negative value (a negative dielectric constant) and the dielectric constant in the imaginary part can be smaller than an absolute value of the dielectric constant in the real part in the case in which a specific electric field is applied. As an example of the metal which can have such a dielectric constant in the visible light range, there can be cited silver (Ag), gold (Au), aluminum (Al), copper (Cu), platinum (Pt), nickel (Ni), tungsten (W), rhodium (Rh), ruthenium (Ru), alloys of any of these materials, and so on.

The mirror layer 10 can have a function of generating the propagating surface plasmon (PSP) in the electric field enhancement element 100 according to the present embodiment. Under a specific condition, by the light entering the mirror layer 10, it is possible to generate the propagating surface plasmon in the vicinity of the surface (the end surface in the thickness direction) of the mirror layer 10. In the present specification, a quantum of the vibration formed of the vibration of the charges in the vicinity of the surface of the mirror layer 10 and the electromagnetic wave combined with each other is referred to as a surface plasmon polariton (SPP) in some cases. It is also possible to make the propagating surface plasmon generated on such a mirror layer 10 interact with a localized surface plasmon generated on the metal fine structure layer 30 described later.

### 1.2. Magnetooptic Material Layer

The electric field enhancement element 100 according to the present embodiment includes the magnetooptic material layer 20. The magnetooptic material layer 20 is disposed between the metal fine structure layer 30 and the mirror layer 10. The magnetooptic material layer 20 can also be disposed so as to have contact with the mirror layer 10, or disposed so as to be separated from the mirror layer 10. In the case in which the magnetooptic material layer 20 is disposed so as to be separated from the mirror layer 10, a dielectric layer (described later) or the like can also be disposed in between. Further, the magnetooptic material layer 20 can also be disposed so as to have contact with the metal fine structure layer 30, or disposed so as to be separated from the metal fine structure layer 30. In the case in which the magnetooptic material layer 20 is disposed so as to be separated from the metal fine structure layer 30, the dielectric layer or the like can also be disposed in between, or the metal fine structure layer 30 can also be disposed above the magnetooptic material layer 20 via a space. Further, a plurality of magnetooptic material layers 20 can be disposed between the metal fine structure layer 30 and the mirror layer 10, and it is also possible for the magnetooptic material layer 20, the dielectric layer, and the space to be arranged between the metal fine structure layer 30 and the mirror layer 10 in an arbitrary order.

By the magnetic field generation device 40 described later applying a magnetic field to the magnetooptic material layer 20, the magnetooptic material layer 20 can cause at least one of a Faraday effect and a Cotton-Mouton effect. By applying the magnetic field to the magnetooptic material layer to cause these effects, the refractive index of the magnetooptic material layer 20 is changed, and thus, the light path length between the metal fine structure layer 30 and the mirror layer 10 can be changed.

Here, the light path length denotes the optical length of a path along which the light proceeds, and corresponds to the product of the physical length (actual spatial dimension) of the path along which the light proceeds and the refractive index. In other words, even if the dimension (e.g., the thickness) of the magnetooptic material layer 20 does not change, if the refractive index changes, the optical length (the light path length) of the path of the light proceeding in the magnetooptic material layer 20 changes.

The magnetooptic material layer 20 is formed of a magnetooptic material high in transparency in at least the wavelength of the incident light i. The Faraday effect and the Cotton-Mouton effect are the effects caused when a magnetic field is applied to a magnetooptic material, and are each one of magnetooptic effects although the name is different by the type. The two magnetooptic effects are distinguished by the direction of the light entering the magnetooptic material and the direction in which the magnetic field is applied. Specifically, the application direction of the magnetic field can be set to the same direction as the incident direction of the light in the magnetooptic material layer 20 or a direction perpendicular to the incident direction, and the two magnetooptic effects can be used in accordance with the condition.

Here, in relation to the direction of the incident light and the direction in which the magnetic field is applied, the case of applying the magnetic field having a direction parallel to the direction of the light entering the magnetooptic material is referred to as Faraday geometry, while the case of applying the magnetic field having a direction perpendicular to the direction of the light entering the magnetooptic material is referred to as Voigt geometry. In FIGS. 1 through 4, the direction of the magnetic field is drawn as arrows in imitation of the magnetic field lines. The electric field enhancement element 100 shown in FIG. 1 is an example of the Faraday geometry in which the magnetic field having a direction parallel to the direction of the incident light i entering the magnetooptic material layer 20. The electric field enhancement element 101 shown in FIG. 2 is an example of the Voigt geometry in which the magnetic field having a direction perpendicular to the direction of the incident light i entering the magnetooptic material layer 20.

When a magnetic field is applied to the magnetooptic material, magnetization M corresponding to the magnetic field occurs in the magnetooptic material, and the refractive index of the magnetooptic material varies in accordance with the magnitude and the direction (orientation) of the magnetization. Further, it is also possible to cause anisotropy in the refractive index of the magnetooptic material due to the difference between the Faraday geometry and the Voigt geometry and the direction of the incident light.

When inputting the light to the magnetooptic material in the Faraday geometry, and varying the intensity of the magnetic field to be applied, the refractive index in right circularly polarized light and left circularly polarized light varies. This is known as the Faraday effect in which the polarization plane rotates due to the difference between right circularly polarized light and left circularly polarized light when inputting linearly polarized light to the magnetooptic material magnetized. Further, in the case of the Voigt geometry, in the case in which the incident direction of the light is set to a Z direction, the refractive indexes in the X direction and the Y direction perpendicular to the Z direction become different from each other. This is known as the Cotton-Mouton effect, and the refractive index in the Z direction varies in accordance with the magnitude of the magnetization M of the magnetooptic material.

By using these two effects, the light path length (the product of the refractive index and the physical length) can be varied between before and after the magnetization, or in accordance with the orientation (direction) of the magnetization M. Further, in the case in which the light is input in the Faraday geometry and the Voigt geometry, the relationship between the polarization direction of the light, the range in which the refractive index is varied, and the magnitude (orientation) of the magnetization M to be induced is different between the geometries as described below. Specifically, in the case of inputting the linearly polarized light in the Faraday geometry, the refractive index can be varied by varying (in the range of 0 through ±M) the magnitude (the absolute value) of the magnetization M independently of the orientation of the magnetization M, and in the case of inputting the linearly polarized light in the Voigt geometry, the refractive index can also be varied by varying (in the range of 0 through ±M) the magnitude (the absolute value) of the magnetization M independently of the orientation of the magnetization M. In contrast, in the case of inputting circularly polarized light in the Faraday geometry, the refractive index can be varied by varying (in the range of −M through +M) the orientation of the magnetization M and the magnitude of the magnetization M.

Further, although in the above explanation, there is described the case in which the magnetic field having a direction parallel or perpendicular to the direction of the incident light is applied with respect to the Faraday geometry and the Voigt geometry, the direction of the magnetic field is not required to be strictly parallel or perpendicular, and if the magnetic field has a component in a direction parallel or perpendicular to the direction of the incident light, the effect described above corresponding to the component can be exerted. Further, both of the Faraday effect and the Cotton-Mouton effect appear in some cases in accordance with the component in the direction parallel or perpendicular to the direction of the incident light.

In the electric field enhancement element 100 according to the present embodiment, if one of the Faraday effect, the Cotton-Mouton effect, or both of the Faraday effect and the Cotton-Mouton effect is exerted, the light path length of the light proceeding in the magnetooptic material layer 20 can be varied. However, from the viewpoint of making the refractive index easier to vary and making the control easier, it is more preferable to use circularly polarized light as the incident light i in the case of the Faraday geometry, and to use linearly polarized light as the incident light i in the case of the Voigt geometry.

The magnetooptic material layer 20 is not limited as long as the magnetooptic material layer is formed of a material in which such effects are exerted, but it is preferable to use a rare earth iron garnet type material as a suitable material in the visible light range used for the Raman measurement.

The rare earth iron garnet type material exhibits a garnet type crystal structure. A general composition formula of the rare earth iron garnet is expressed as R₃Fe₅O₁₂. Here, R represents a rare-earth element. As the rare earth element, there can be cited scandium (Sc), yttrium (Y), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu), and R can be set to at least one species selected from these elements.

In contrast, the composition of the rare earth iron garnet can be different from the expression of R₃Fe₅O₁₂ within a range in which the material can take the garnet type crystal structure. For example, R and Fe can also be replaced with other elements, and the number of O (oxygen) in the formula is not required to exactly be 12. For example, the material of the magnetooptic material layer 20 of the present embodiment can also be a material, which has the garnet type crystal structure, and can be expressed by the composition formula of R₃₋ₓBiₓFe_{5-y}A_{y}O₁₂. [In the composition formula, R represents at least one element selected from scandium (Sc), yttrium (Y), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu), Bi represents bismuth, Fe represents iron, A represents at least one element selected from gallium (Ga) and aluminum (Al), O represents oxygen, and x and y exist within the ranges of 0≦x<3 and 0≦y<5, respectively.]

If such a rare earth iron garnet type material is used as the material of the magnetooptic material layer 20, high permeability to the incident light i (e.g., light with a wavelength of 633 nm) is provided, and further, a significant variation in refractive index can be obtained with respect to the applied magnetic field.

The thickness of the magnetooptic material layer 20 is not particularly limited, and can be set to be, for example, no smaller than 10 nm and no larger than 2000 nm, preferably no smaller than 20 nm and no larger than 500 nm, and more preferably no smaller than 20 nm and no larger than 300 nm. In the present embodiment, although the light path length can be varied by varying the refractive index of the magnetooptic material layer 20, since the range in which the light path length can be varied is proportional to the thickness of the magnetooptic material layer 20, it is also possible to set the thickness of the magnetooptic material layer 20 in accordance with the shift amount (the effective range for the compensation of the shift) of the peak of the reflectance and so on. Further, the thickness of the magnetooptic material layer 20 can be designed taking the wavelength λᵢ of the incident light i with which the electric field enhancement element 100 is irradiated, the wavelength λₛ of the Raman scattering light s obtained when inputting the light with the wavelength λᵢ, and so on into consideration.

The magnetooptic material layer 20 can be formed by a process such as a vapor deposition process, a sputtering process, a CVD process, or a variety of types of coating processes. In the magnetooptic material layer 20, an area sandwiched by the mirror layer 10 and the metal fine structure layer 30 can be assumed as an Insulator (an insulating layer) having a metal-insulator-metal (MIM) structure if using metal as the mirror layer 10 and taking the metal fine structure layer 30 as one layer (see FIG. 6). Further, in this case, the magnetooptic material layer 20 can be thought to be a waveguide having boundaries defined by metal disposed on the upper and lower sides. Therefore, the light can be propagated in the magnetooptic material layer 20 (in the planar direction, namely the direction parallel to the magnetooptic material layer 20). Further, in the example shown in the drawings, the magnetooptic material layer 20 is formed so as to have contact with the mirror layer 10, and is capable of propagating the propagating surface plasmon (PSP), which is generated in the vicinity of the interface between the magnetooptic material layer 20 and the mirror layer 10, in the magnetooptic material layer 20 (in the planar direction).

Further, in the case of assuming the metal fine structure layer 30 as one layer, it can be assumed that the mirror layer 10 and the metal fine structure layer 30 form a resonator having a structure in which the light is reflected at both ends, and the magnetooptic material layer 20 is disposed in a light path of the resonator. In such a resonator, superposition between the incident light i and the reflected light can be caused. By setting the thickness of the magnetooptic material layer 20 so that an antinode of the standing wave caused by the superposition between the incident light i and the reflected light is located in the vicinity of the center (see the dashed-two dotted line C shown in FIG. 6) in the thickness direction of the metal fine structure layer 30, the intensity of the LSP caused on the metal fine structure layer 30 can further be enhanced. It is also possible to set the thickness of the magnetooptic material layer 20 taking such a point into consideration.

### 1.3. Metal Fine Structure Layer

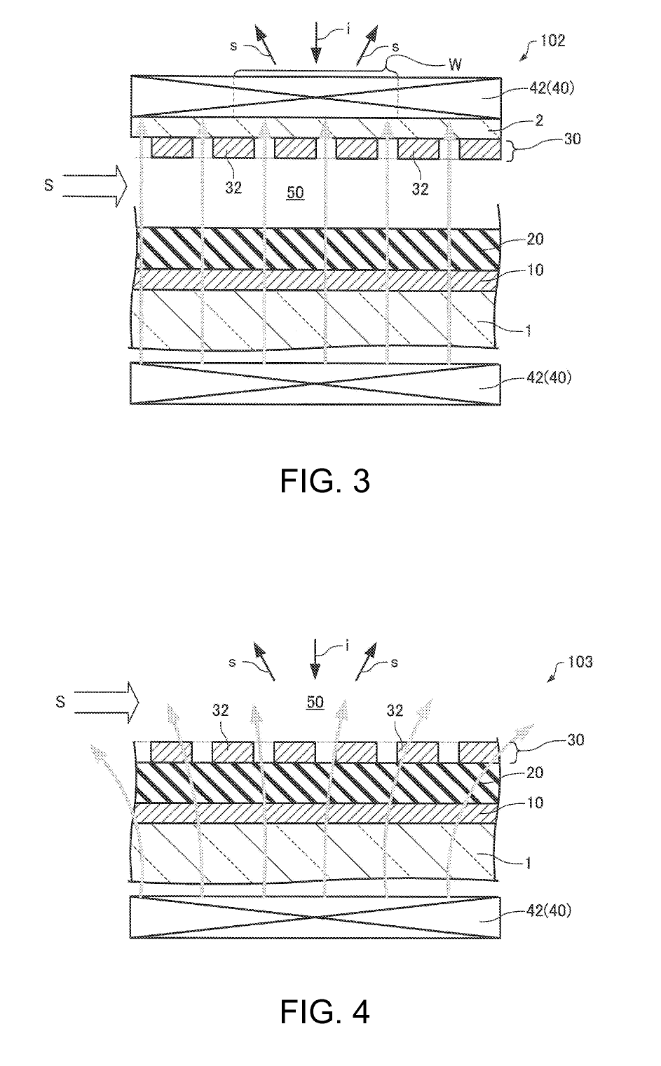

The metal fine structure layer 30 is configured including metal fine structures 32 smaller in size than the wavelength of the incident light. In the example shown in FIG. 1, the metal fine structure layer 30 is disposed so as to have contact with the surface of the magnetooptic material layer 20. As already described, the metal fine structure layer 30 can also be disposed above the magnetooptic material layer 20 via another layer, or can also be disposed via a space. In the case in which the metal fine structure layer 30 is disposed above the magnetooptic material layer 20 via a space, the metal fine structure layer 30 can also be provided to another substrate 2 for supporting the metal fine structure layer 30 as in the case of, for example, the electric field enhancement element 102 shown in FIG. 3.

The metal fine structure layer 30 is configured including the plurality of metal fine structures 32. Although the metal fine structures 32 each have a particulate structure (a metal particle) in the examples shown in the drawings, the metal fine structures 32 are not limited to such a configuration. The number, the shape, the arrangement, and so on of the metal fine structures 32 included in the metal fine structure layer 30 are not particularly limited. Further, the metal fine structure layer 30 can also include a gas (a space), a dielectric material, and so on besides the metal fine structures 32.

The metal fine structure layer 30 is defined as a part located between the surface having contact with lower ends of the metal fine structures 32 and the surface having contact with upper ends thereof. For example, it is assumed that in the case in which the metal fine structure layer 30 includes the metal fine structures 32 and a gas (a space), the upper surface and the lower surface of the metal fine structure layer 30 become imaginary planes, and the gas (the space) disposed on the lateral side of each of the metal fine structures 32 is also included in the metal fine structure layer 30.

The metal fine structures 32 included in the metal fine structure layer 30 are not particularly limited as long as the metal fine structures 32 can generate the localized surface plasmon due to the irradiation with the incident light i. FIG. 5 shows an example of the metal fine structures 32 included in the metal fine structure layer 30 as particulate fine structures (metal particles). Further, the metal fine structure layer 30 can have a striped shape in which the plurality of metal fine structures 32 is arranged side by side in a predetermined direction at a predetermined pitch in a planar view, namely the metal fine structures 32 can be arranged so as to form a grating (stripes) in the planar view. Further, the metal fine structure layer 30 can be provided with a two-dimensional grating structure in which there is included a plurality of metal fine structure arrays each having a plurality of metal fine structures 32 arranged side by side at a predetermined pitch in a predetermined direction in the planar view, and the metal fine structure arrays are arranged side by side at a predetermined pitch in a direction intersecting with the predetermined direction.

In the case in which the metal fine structure layer 30 is formed of the metal fine structures 32 having the particulate or striped shape, the number of the metal fine structures 32 is only required to be two or more, and is preferably equal to or larger than 10, and more preferably equal to or larger than 100. It should be noted that the shapes of the metal fine structures 32 can be the same as each other, or different from each other, and for example, the metal fine structures 32 each having a stripe shape and the metal fine structure 32 each having a particulate shape can exist in a mixed manner.

The metal fine structures 32 are each disposed separately from the mirror layer 10 in the thickness direction via at least the magnetooptic material layer 20. In the examples shown in FIGS. 1 through 4, the metal fine structures 32 are arranged above the mirror layer 10 via the magnetooptic material layer 20.

The shapes of the metal fine structures 32 are not particularly limited, and in the case of, for example, adopting the particulate structures, the shapes can be circular shapes, elliptical shapes, polygonal shapes, infinite shapes, or shapes obtained by combining these shapes in the case of projecting the metal fine structures 32 in the thickness direction of the mirror layer 10 (in the planar view from the thickness direction), and can also be circular shapes, elliptical shapes, polygonal shapes, infinite shapes, or shapes obtained by combining these shapes in the case of projecting the metal fine structures 32 in a direction perpendicular to the thickness direction of the mirror layer 10. Although the metal fine structures 32 can each be provided with a columnar shape having a center axis along the thickness direction of the mirror layer 10, the shape of each of the metal fine structures 32 is not limited to this shape, but can be, for example, a prismatic shape, an elliptic cylindrical shape, a hemispherical shape, a spherical shape, a pyramid shape, or a frustum shape.

The dimension of each of the metal fine structures 32 is smaller than the wavelength (e.g., 633 nm) of the incident light i, and is, for example, no smaller than 5 nm and no larger than 600 nm. Specifically, the size in a direction perpendicular to the height direction of the metal fine structure 32 denotes the length of a zone in which the metal fine structure 32 can be cut by a plane perpendicular to that direction, and is set to be no smaller than 5 nm and no larger than 600 nm. Further, in the case in which the shape of the metal fine structure 32 is a cylinder having the center axis along the height direction, the size (the diameter of the bottom surface of the cylinder) of the metal fine structure 32 can be set to be no smaller than 10 nm and no larger than 600 nm, preferably no smaller than 20 nm and no larger than 400 nm, more preferably no smaller than 25 nm and no larger than 300 nm.

The size T in the height direction (the thickness direction of the magnetooptic material layer 20) of the metal fine structure 32 denotes the length of a zone in which the metal fine structure 32 can be cut by a plane perpendicular to the height direction, and can be set to be no smaller than 1 nm and no larger than 300 nm. In the case in which, for example, the shape of the metal fine structure 32 is a cylinder having a center axis along the height direction, the size (the height of the cylinder) in the height direction of the metal fine structure 32 can be set to be no smaller than 1 nm and no larger than 300 nm, preferably no smaller than 2 nm and no larger than 100 nm, more preferably no smaller than 3 nm and no larger than 50 nm, and further preferably no smaller than 4 nm and no larger than 40 nm.

The shape and the material of the metal fine structure 32 are arbitrary as long as the localized surface plasmon (LSP) can be generated due to the irradiation with the incident light i. As the material which can generate the localized surface plasmon due to the irradiation with light around the visible light range, there can be cited gold (Au), silver (Ag), aluminum (Al), copper (Cu), platinum (Pt), palladium (Pd), nickel (Ni), tungsten (W), rhodium (Rh), ruthenium (Ru), and alloys of any of these materials. Among these materials, Au and Ag are more preferable as the material of the metal fine structures 32. By selecting such materials, the LSP having higher intensity can be obtained in some cases, and the degree of the electric field enhancement of the whole element can be enhanced.

The metal fine structures 32 can be formed using, for example, a method of forming a thin film using a sputtering process, an evaporation process, and so on and then performing patterning, a micro-contact printing method, or a nanoimprint method. Further, the metal fine structures 32 can be formed using, for example, a lithography method of exposing a resist, which is applied on the substrate, with an electron beam lithography or the like, depositing a metal thin film using a sputtering process, an evaporation process, or the like, and then removing the resist to thereby perform patterning. Further, the metal fine structures 32 can also be formed using a colloid chemical method, and can also be arranged using an arbitrary method. Further, the metal fine structures 32 can also be formed using an interference exposure method. Specifically, the exposure for forming the pattern can be performed using the interference pattern of the laser beam. Further, according to this method, multiple exposure and multiple beam exposure are possible, and the metal fine structures 32 having a periodic pattern can be formed with extreme ease. For example, in the case of forming a striped pattern, such a pattern can be formed by exposing the resist or the like to the interference pattern of the laser beam. Further, in the case of forming a pattern having a two-dimensional lattice shape, such a pattern can be formed by exposing the resist or the like to the interference pattern of the laser beam in an intersecting manner at the same time or in a batch manner. Such a method can make the device configuration small in scale compared to the electron beam lithography, and at the same time, can more efficiently manufacture a large number of electric field enhancement elements 100 on demand.

The metal fine structures 32 have a function of generating a localized surface plasmon (LSP) in the electric field enhancement element 100 according to the present embodiment. By irradiating the metal fine structures 32 with the incident light i in a specific condition, the localized surface plasmon can be generated in the periphery of the metal fine structures 32. It is also possible to set the wavelength of the incident light i, the distance between the mirror layer 10 and the metal fine structure layer 30, the arrangement of the metal fine structures 32, and so on so that the localized surface plasmon (LSP) generated in the metal fine structures 32 can interact with the propagating surface plasmon (PSP) generated in the vicinity of the upper surface of the mirror layer 10.

It should be noted that in the examples shown in FIGS. 1 through 4, the plurality of metal fine structures 32 is disposed in a periodic manner, but can also be arranged randomly instead of the periodic arrangement. In the case in which the plurality of metal fine structures 32 is disposed in a periodic manner, the period can be set to be, for example, no smaller than 10 nm and no larger than 1000 nm.

In the electric field enhancement element 100, the metal fine structure layer 30 is irradiated with the incident light i (excitation light). Then, the incident light i performs a variety of interactions such as diffraction, refraction, and reflection with the metal fine structure layer 30 and the mirror layer 10 to generate the plasmon resonance in the area irradiated with the incident light i and the vicinity of the area, and can thus exhibit the high electric field enhancement effect.

In the electric field enhancement element 100 hereinabove described as an example, an extremely large enhanced electric field is formed in the vicinity of the metal fine structures 32 of the metal fine structure layer 30 with the irradiation of the incident light i. Therefore, by irradiating the metal fine structures 32 of the metal fine structure layer 30 of the electric field enhancement element 100 with the incident light i in the state in which the target substance is adsorbed (attached, contacted) to the metal fine structures 32, both of the incident light i and the Raman scattering light due to the target substance can significantly be amplified. It should be noted that the target substance is a substance to be the object of the detection in the analysis using the electric field enhancement element 100. Further, the adsorption denotes a phenomenon that the concentration increases to a level higher than in the periphery in an interface of an object.

When the target substance adhering to the metal fine structures 32 is irradiated with the incident light i, the Rayleigh scattering light having the same wavelength as that of the incident light i, and the Raman scattering light s having a wavelength different from the wavelength of the incident light i are generated as the scattering light, and are then received (detected) in a photodetector (not shown). The difference in energy between the incident light i and the Raman scattering light s corresponds to the specific vibration energy corresponding to the structure of the target substance. Therefore, by obtaining the Raman shift, which is a difference between the wave number (frequency) of the Raman scattering light s and the wave number of the incident light i, the target substance can be identified.

The metal fine structures 32 cause the surface plasmon resonance (SPR) due to the incident light i. Specifically, the metal fine structures 32 cause the localized surface plasmon resonance (LSPR) due to the incident light i. Here, the LSPR denotes the phenomenon that when light is input to a metal particle smaller than the wavelength of the light, the free electrons existing in the metal vibrate collectively due to the electric field component of the light, and thus a localized electric field is externally induced. Due to the localized electric field, the Raman scattering light s can be enhanced.

The incident light i (at least apart of the incident light i) entering the electric field enhancement element 100 is multiply reflected between the metal fine structure layer 30 and the mirror layer 10. Specifically, in the case in which the mirror layer 10 and the metal fine structure layer 30 are disposed in parallel to each other, at least a part of the incident light i resonates (resonance) forming a standing wave between the both layers, and thus, the LSPR can strongly be developed. In the electric field enhancement element 100, by applying a magnetic field to the magnetooptic material layer 20 using the magnetic field generation device 40, it is possible to vary the refractive index of the magnetooptic material layer 20 to thereby vary the light path length of the incident light i (the standing wave) multiply reflected between the mirror layer 10 and the metal fine structure layer 30.

In the electric field enhancement element 100 according to the present embodiment, a sample including the target substance has contact with the metal fine structure layer 30. The position where the sample has contact with the metal fine structure layer 30 can be located on the upper surface or the lower surface of the metal fine structure layer 30. In other words, a flow channel 50 of the sample can be formed on the upper surface side of the metal fine structure layer 30 as shown in FIGS. 1, 2, and 4, or can be formed on the lower surface side of the metal fine structure layer 30 as shown in FIG. 3. In other words, in the examples shown in FIGS. 1, 2, and 4, the flow channel 50 is formed on the opposite side of the metal fine structure layer 30 to the magnetooptic material layer 20, while in the example shown in FIG. 3, the flow channel 50 is formed between the metal fine structure layer 30 and the magnetooptic material layer 20.

### 1.4. Plasmon Resonance Wavelength

FIG. 5 shows the gap type surface plasmon (GSP) structure. As shown in FIG. 5, in the GSP structure, the magnetooptic material layer 20 is disposed above the mirror layer 10, and the plurality of metal fine structures 32 is disposed above the magnetooptic material layer 20. FIG. 6 is a diagram in which the GSP structure shown in FIG. 5 is assumed as a laminate film structure, and the metal fine structures 32 and the periphery (air) are assumed as a single metal fine structure layer 30 (pseudo layer).

In the laminate film structure shown in FIG. 6, the light path length can be set so that the antinode of the standing wave, which is obtained by superimposing the incident wave (incident light) input from the metal fine structure layer 30 side and the reflected wave (reflected light) generated on the interface of each layer, is located on the center line (the line passing through the middle of the upper surface and the lower surface of the metal fine structure layer 30) C of the metal fine structure layer 30. In this case, the plasmon resonance wavelength λ can approximately be expressed as Formula 1 described below.

$$m \cdot λ = {n}_{particle} \cdot {d}_{particle} + 2 {n}_{gap} \cdot {d}_{gap} + \frac{{φ}_{mirror}}{2 π} λ \qquad ( 1 )$$

It should be noted that in Formula 1, m represents an integer, n_{particle} represents the refractive index of the metal fine structure layer 30, d_{particle} represents the film thickness of the metal fine structure layer 30, n_{gap} represents the refractive index of the magnetooptic material layer 20, d_{gap} is the film thickness of the magnetooptic material layer 20, and φₘᵢᵣᵣₒᵣ represents the phase variation [rad] generated in the reflection on the interface between the magnetooptic material layer 20 and the mirror layer 10.

In the case in which the mirror layer 10 is a single metal layer, φₘᵢᵣᵣₒᵣ is expressed as Formula 2 described below.

$${φ}_{mirror} = {tan}^{- 1} ( \frac{2 \cdot {n}_{gap} \cdot {κ}_{mirror}}{{n}_{gap}^{2} - {n}_{mirror}^{2} - {κ}_{mirror}^{2}} ) \qquad ( 2 )$$

It should be noted that in Formula 2, nₘᵢᵣᵣₒᵣ represents the refractive index of the mirror layer 10, and κₘᵢᵣᵣₒᵣ represents the extinction coefficient of the mirror layer 10. In the case in which the mirror layer 10 is formed of a dielectric mirror, if the magnetooptic material layer 20 is higher in refractive index than the first layer (the layer having contact with the magnetooptic material layer 20) of the dielectric mirror φₘᵢᵣᵣₒᵣ=0 is obtained, and if the magnetooptic material layer 20 is lower in refractive index than the first layer of the dielectric mirror, φₘᵢᵣᵣₒᵣ=π is obtained. Further, in the case in which the magnetooptic material layer 20 is formed of a laminate body with a plurality of layers, it is desirable to satisfy Formula 1 in each of the layers.

FIG. 7 shows the reflectance characteristics with respect to the wavelength of the incident light i in the electric field enhancement element (a sensor chip) having the GSP structure using an Au layer as the mirror layer 10, air as the magnetooptic material layer 20, and Ag nanoparticles as the metal fine structures 32. FIG. 7 shows a simulation result by a computer. The reflectance is obtained from the ratio of the intensity of the reflected light to the intensity of the incident light when inputting the light to the electric field enhancement element from the Ag nanoparticle side.

As shown in FIG. 7, the light absorption due to the surface plasmon resonance is observed at 633 nm, which is the wavelength of the incident light entering the optical element. The absorption derives from the LSPR excited by an optical electric field obtained by superimposing the incident light and the reflected light generated on each interface.

In the SERS optical element for detecting a substance using the enhanced electric field due to the surface plasmon resonance, the wavelength of the surface plasmon resonance is made coincide with the wavelength of the incident light, or the Raman scattering wavelength of the detection object. It is said that the degree of the SERS enhancement is proportional to the product of the square of the degree of the electric field enhancement at the incident wavelength and the square of the degree of the electric field enhancement at the Raman scattering wavelength. In the sensor chip having the GSP structure, it is possible to arbitrarily set the dimension of the metal nanoparticle, the film thickness of the gap layer, and so on to thereby adjust the plasmon resonance wavelength.

However, in the case in which the sample is introduced in the flow channel, and the substance has contact with the metal fine structure layer 30, a shift occurs in the plasmon resonance wavelength in accordance with the type and amount of the substance (see FIG. 7). Therefore, in the plasmon resonance wavelength at the time of design, the degree of electric field enhancement drops in some cases. This means that roughly 60% of the variation in reflectance indicated by the arrow shown in FIG. 7 fails to make an energy contribution for forming the enhanced electric field.

To deal with the problem described above, in the electric field enhancement element 100 according to the present embodiment, there is disposed the magnetooptic material layer 20 capable of varying the light path length between the metal fine structure layer 30 and the mirror layer 10 by applying a magnetic field, and the shift of the plasmon resonance wavelength can be compensated. The compensation amount can be adjusted by the thickness of the magnetooptic material layer 20 and the value of the magnetic field to be applied.

### 1.5. Magnetic Field Generation Device

The electric field enhancement element 100 according to the present embodiment includes the magnetic field generation device 40. The magnetic field generation device 40 applies a magnetic field to the magnetooptic material layer 20. The magnetic field generation device 40 is provided with a shape not shielding the incident light input to the electric field enhancement element 100 and the light radiated from the electric field enhancement element 100, or disposed at a position where the magnetic field generation device 40 fails to shield the incident light and the light thus radiated. In the examples shown in FIGS. 1 and 3, the magnetic field generation device 40 has a window W through which the incident light i from the outside and the Raman scattering light s from the metal fine structure layer 30 can pass. Further, the magnetic field generation device 40 can apply the magnetic field to the magnetooptic material layer 20 transmitting another member. In such a case, the another member is formed of a material having permeability to the magnetic field.

The magnetic field generation device 40 can be formed of, for example, a coil (electric magnet) or a permanent magnet. In the case in which the magnetic field generation device 40 is formed of a coil, the intensity and the orientation of the magnetic field to be applied are easily changed. Further, in the case in which the magnetic field generation device 40 is formed of a permanent magnet, the intensity and the orientation of the magnetic field to be applied can be changed by, for example, attaching or detaching, reversing, or replacing the permanent magnet. Further, the magnetic field generation device 40 can also be formed by combining the permanent magnet and the electric magnet with each other.

In the example shown in FIG. 1, the magnetic field generation device 40 has a configuration of sandwiching the layers with two coils 42 disposed on the outer sides of the substrate 1 and the metal fine structure layer 30, respectively, and is disposed so as to apply the magnetic field to the magnetooptic material layer 20 from the normal direction. In FIGS. 1 and 3, the direction of the magnetic field generated by the magnetic field generation device 40 is set to be roughly parallel to the incident direction of the incident light i, and FIGS. 1 and 3 show an example of the Faraday geometry.

In contrast, in the example of the electric field enhancement element 101 shown in FIG. 2, the magnetic field generation device 40 has a configuration of sandwiching the layers with two coils 42 disposed on the lateral sides (in the direction perpendicular to the thickness direction) of the magnetooptic material layer 20, and is disposed so as to apply the magnetic field to the magnetooptic material layer 20. In FIG. 2, the direction of the magnetic field generated by the magnetic field generation device 40 is set to be roughly perpendicular to the incident direction of the incident light i, and FIG. 2 shows an example of the Voigt geometry.

In the examples shown in FIGS. 1 through 3, since the Faraday geometry or the Voigt geometry is provided, the light path length of the light passing through the magnetooptic material layer 20 can more efficiently be varied.

It should be noted that as shown in FIG. 4, the magnetic field can also be applied to the magnetooptic material layer 20 using a configuration of forming the magnetic field generation device 40 using a single coil 42 disposed on the outer side of the substrate 1 or the metal fine structure layer 30. In the example shown in FIG. 4, there occur some areas where the direction of the magnetic field generated by the magnetic field generation device 40 is oblique with respect to the incident direction of the incident light i, and there is provided a geometry obtained by mixing the Faraday geometry and the Voigt geometry. Even in such an arrangement, since both of the Faraday effect and the Cotton-Mouton effect can be obtained, the refractive index of the magnetooptic material layer 20 can be varied.

### 1.6. Other Constituents

### 1.6.1. Flow Channel

The electric field enhancement element 100 according to the present embodiment can also be configured including the flow channel 50. In the flow channel 50, there is introduced the sample S including the target substance. The flow channel 50 forms a distribution channel of the fluid sample such as a liquid or a gas including the target substance. The flow channel 50 is formed so as to be able to make the fluid sample including the target substance have contact with the metal fine structure layer 30. In FIGS. 1 through 4, the flow of the sample S is schematically indicated by the arrows.

In the examples shown in FIGS. 1, 2, and 4, the flow channel 50 is formed on the opposite side of the metal fine structure layer 30 to the magnetooptic material layer 20. In this case, the flow channel 50 can be formed including the configuration of the magnetic field generation device 40, or can also be formed using, for example, a configuration of the Raman spectroscopic device to which the electric field enhancement element 100 is attached. Further, in the example shown in FIG. 3, the flow channel 50 is formed on the same side of the metal fine structure layer 30 as the magnetooptic material layer 20. In this case, the flow channel 50 can be formed using another substrate 2. Further, in this case, the substrate 1 or the another substrate 2 can be provided with a projection or the like not shown, and can also be configured so as to be opposed to each other to thereby form a space to be the flow channel 50.

### 1.6.2. Dielectric Layer

Although not shown in the drawings, the electric field enhancement element 100 can also include a dielectric layer. The dielectric layer can be formed between the mirror layer 10 and the metal fine structure layer 30. The dielectric layer can be formed above, below, or above and below the magnetooptic material layer 20. Further, the magnetooptic material layer 20, the dielectric layer, and the space can be disposed in an arbitrary order between the mirror layer 10 and the metal fine structure layer 30.

The dielectric layer can have a shape of a film, a layer, or a membrane. The dielectric layer is only required to have a positive dielectric constant, and can be formed of, for example, SiO₂, Al₂O₃, TiO₂, a polymer, or indium tin oxide (ITO). Further, the dielectric layer can be formed of a plurality of layers different in material from each other. Among these materials, SiO₂ is more preferable as the material of the dielectric layer. According to this configuration, in measuring the sample using the incident light having a wavelength λᵢ equal to or longer than 400 nm, it is possible to easily enhance both of the incident light i and the Raman scattering light. The thickness of the dielectric layer is not particularly limited, and can be set to be, for example, no smaller than 10 nm and no larger than 2000 nm, preferably no smaller than 20 nm and no larger than 500 nm, and more preferably no smaller than 20 nm and no larger than 300 nm.

Further, the thickness of the dielectric layer is designed taking the wavelength λᵢ of the incident light i with which the electric field enhancement element 100 is irradiated, the wavelength λₛ of the Raman scattering light s obtained when inputting the light with the wavelength λᵢ, and so on into consideration. The dielectric layer can be formed by a process such as a vapor deposition process, a sputtering process, a CVD process, or a variety of types of coating processes.

The light can be propagated in the dielectric layer (in the planar direction, namely the direction parallel to the dielectric layer). Further, in the case in which the dielectric layer is formed so as to have contact with the mirror layer 10, it is possible to propagate the propagating surface plasmon (PSP), which is generated in the vicinity of the interface between the dielectric layer and the mirror layer 10, in the dielectric layer (in the planar direction). Further, in the case of assuming the metal fine structure layer 30 as one layer, the configuration can be assumed as a resonator having a structure in which the light is reflected by the mirror layer 10 and the metal fine structure layer 30 at both ends, and the dielectric layer constitutes a part of the light path of the resonator together with the magnetooptic material layer 20.

### 1.7. Functions and Advantages

The electric field enhancement element 100 explained hereinabove has at least the following features. In the electric field enhancement element 100, the magnetic field can be applied to the magnetooptic material layer 20 using the magnetic field generation device 40. Thus, it is possible to vary the refractive index of the magnetooptic material layer 20.

Further, in the case in which the target substance adsorbs to the metal fine structure 32 to cause the shift of the plasmon resonance wavelength, by adjusting the magnetic field to be applied in accordance with the variation in the plasmon resonance wavelength, it is possible to adjust the light path length between the metal fine structure layer 30 and the mirror layer 10 so that the light path length becomes the length for compensating the shift of the plasmon resonance wavelength. Therefore, in the electric field enhancement element 100, it is possible to easily deal with the variation in the plasmon resonance wavelength.

### 2. Raman Spectroscopic Method

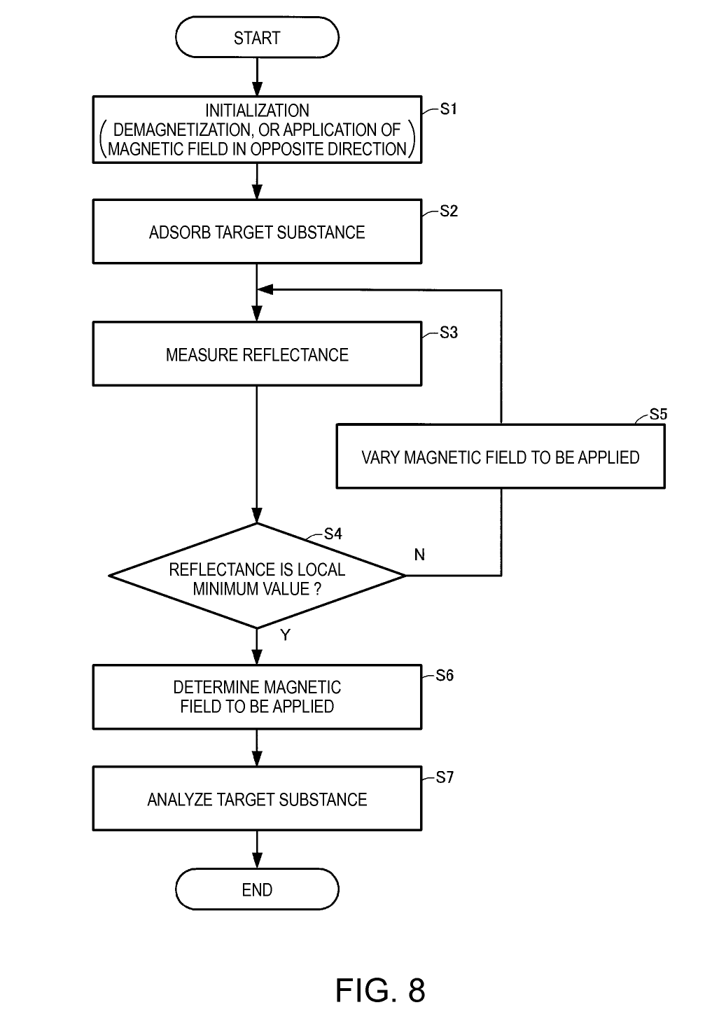

Then, a Raman spectroscopic method according to the present embodiment will be explained with reference to the accompanying drawings. FIG. 8 is a flowchart for explaining the Raman spectroscopic method according to the present embodiment. In the Raman spectroscopic method according to the present embodiment, the electric field enhancement element according to the invention is used. Hereinafter, an example of using the electric field enhancement element 100 as the electric field enhancement element according to the invention will be explained.

As shown in FIG. 8, the Raman spectroscopic method according to the present embodiment includes a process (step S1) of initializing the magnetization of the magnetooptic material layer 20 of the electric field enhancement element 100, a process (step S2) of making the metal fine structure layer 30 of the electric field enhancement element 100 adsorb the target substance, a process (step S3) of applying the incident light from the metal fine structure layer side to the electric field enhancement element 100, then detecting the light reflected by the electric field enhancement element, and then measuring the reflectance, a process (step S4) of determining whether or not the reflectance is a local minimum value, a process (step S5) of changing the magnetic field to be applied to the magnetooptic material layer 20, a process (step S6) of determining the magnetic field with which the reflectance takes the local minimum value, and a process (step S7) of analyzing the target substance based on the light thus detected in the state in which the magnetic field making the reflectance have the local minimum value is applied to the magnetooptic material layer 20. Hereinafter, the specific explanation will be presented.

The Raman spectroscopic method according to the present embodiment can also include a process of preparing the electric field enhancement element 100. The electric field enhancement element 100 is designed so as to have the plasmon resonance wavelength in a range, which can be covered by the refractive index variation of the magnetooptic material layer 20, located on the shorter wavelength side or the longer wavelength side than the wavelength (target wavelength) at which the plasmon resonance is desired to finally be developed in the state in which the sample including the target substance does not have contact, and no magnetic field is applied to the magnetooptic material layer 20.

Here, the target wavelength is normally set to the midpoint between the wavelength of the incident light i for exciting the Raman scattering and the wavelength of the Raman scattering light of the target substance (the target molecule). Further, in the case in which the two wavelengths can be assumed to be sufficiently close to each other, it is possible to use the wavelength of the incident light as the target wavelength. In the following explanation, the wavelength of the incident light is used as the target wavelength. For example, by adjusting the shape, the size, and so on of the metal fine structure 32, the electric field enhancement element 100 can be designed so as to have the plasmon resonance wavelength on the shorter wavelength side or the longer wavelength side than the wavelength of the incident light i. For example, the electric field enhancement element 100 is designed so that the plasmon resonance wavelength is about 630 nm in the case in which the wavelength of the incident light i is 633 nm.

Then, the initialization of the magnetization of the magnetooptic material layer 20 is performed (S1) on the new electric field enhancement element 100 prepared with the design described above, or the electric field enhancement element 100 having been used for another measurement if necessary. As a method of initializing the magnetization, it is arranged that a predetermined magnetization is formed on the magnetooptic material layer 20 using the magnetic field generation device 40. On this occasion, it is not necessarily required to vanish the magnetization (demagnetization), or to form positively or negatively saturated magnetization. In the present process, the magnetooptic material layer 20 is set to a predetermined state between the state with no magnetization and the state in which the saturated magnetization is formed. It should be noted that from the viewpoint of enlarging the range of the variation of the plasmon resonance wavelength, it is more preferable to set the demagnetized state, or the state of the positively or negatively saturated magnetization to the initialized state.

Then, the sample including the target substance is made to have contact with the metal fine structure layer 30 of the electric field enhancement element 100 to make the metal fine structures 32 of the electric field enhancement element 100 adsorb the target substance (S2). Thus, the plasmon resonance wavelength is shifted toward, for example, the longer wavelength than 630 nm. For example, as shown in FIG. 7, the plasmon resonance wavelength becomes about 636 nm.

The reflectance is obtained from the ratio of the intensity of the reflected light in the electric field enhancement element 100 to the intensity of the incident light when inputting the light to the electric field enhancement element 100 from the metal fine structure layer 30 side. It should be noted that in the measurement of the reflected light, it is possible to use calculation from the intensity of the reflected light obtained by inputting the light from a light source separately prepared, or a laser beam with narrow wavelength width used when exciting the Raman scattering light (S3).

Then, whether or not the reflectance thus obtained is the local minimum value is determined (S4). In order to determine whether or not the reflectance is the local minimum value, the reflectance measurement is performed at least two times (S3). Specifically, in the case in which the electric field enhancement element 100 thus prepared is a new one, the reflectance measurement is performed (S3) at least three times, and in the case in which the electric field enhancement element 100 thus prepared is one having been used for another measurement, the reflectance measurement is performed (S3) at least two times using the measurement result of the reflectance in the another measurement.

In the case in which the reflectance fails to become the local minimum value (N in the step S4), the magnetic field to be applied is varied (S5), and then the reflectance measurement is performed again (S3). The variation in the magnetic field applied on this occasion is made so as to find out the local minimum value. Further, even if the strict local minimum value is not obtained, if a satisfiable reflectance has been obtained in the measurement, it is possible to use the value as the local minimum value. In the case in which the reflectance is the local minimum value (Y in the step S4), the value is determined (S6) as the magnetic field to be applied.

Regarding the method of varying the magnetic field, in the case in which the incident light is linearly polarized light, for example, it is possible to vary the magnetic field between the state with no magnetization (demagnetized state) and the state with the largest absolute value of the magnetization (saturated state) to vary the refractive index irrespective of whether the Faraday geometry or the Voigt geometry is used. Further, in the case in which the incident light is circularly polarized light, by adopting the Faraday geometry, and varying the magnetic field between the smallest value (maximum magnetization in the negative direction) of the magnetization and the largest value (maximum magnetization in the positive direction), the refractive index can be varied. Further, since in the magnetooptic material layer 20, the refractive index shows a hysteresis with respect to the magnetic field applied, it is preferable to initialize and adjust the magnetization taking the hysteresis into consideration.

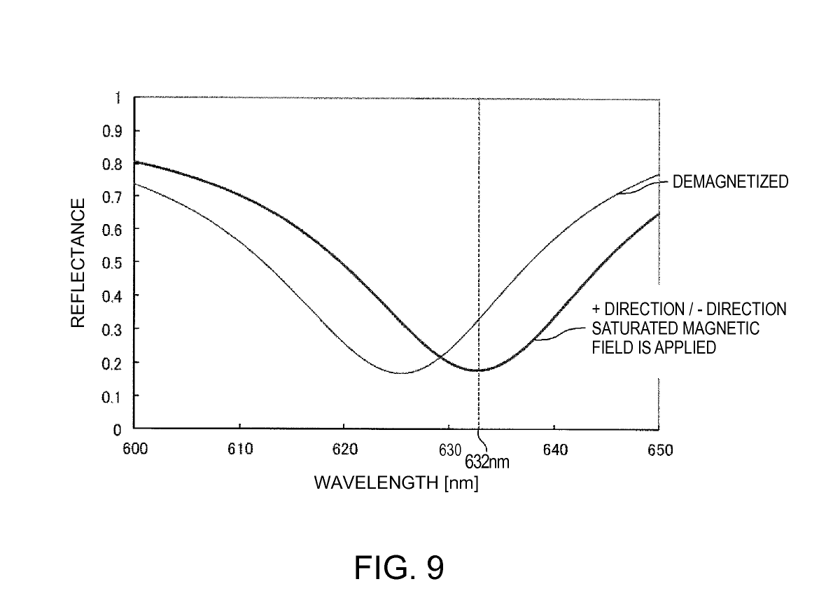

FIG. 9 shows the reflectance characteristics with respect to the wavelength of the incident light in the electric field enhancement element 100. FIG. 9 is obtained by a simulation by a computer. For example, as shown in FIG. 9, although in the demagnetized state of the magnetooptic material layer 20, the local minimum value of the reflectance occurs in the vicinity of 625 nm, by applying the saturated magnetic field in the positive (+) direction or the negative (−) direction, it is possible to make the local minimum value of the reflectance occur in the vicinity of 632 nm.

Therefore, even if the target substance adsorbs to the metal fine structure layer 30 to shift the plasmon resonance wavelength, by repeating the steps S3 through S5, the magnetic field with which the reflectance of the incident light i becomes the local minimum can be determined (step S6).

Then, the target substance is analyzed (qualitatively analyzed or quantitatively analyzed) (step S7) based on the light detected in the state of applying the magnetic field, with which the reflectance becomes the local minimum, to the magnetooptic material layer 20. According to the processes described hereinabove, the target substance can be analyzed.

In the Raman spectroscopic method according to the present embodiment, since the electric field enhancement element 100 is used, the light path length between the metal fine structure layer 30 and the mirror layer 10 can be varied, and thus, it is possible to easily deal with the variation in the plasmon resonance wavelength due to the adsorption of the target substance. Further, the target substance is analyzed based on the light detected in the state of applying the magnetic field, with which the reflectance becomes the local minimum, to the magnetooptic material layer 20 using the electric field enhancement element 100. Therefore, the intensity of the Raman scattering light can be increased. Therefore, in the Raman spectroscopic method according to the present embodiment, the detection sensitivity can be improved.

### 3. Raman Spectroscopic Device

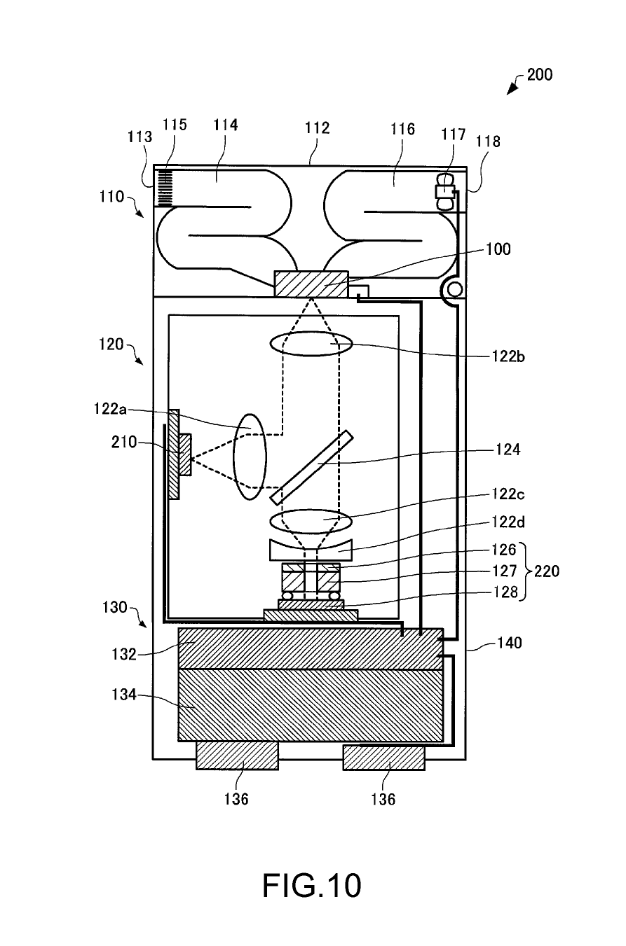

Then, a Raman spectroscopic device according to the present embodiment will be explained with reference to the accompanying drawings. FIG. 10 is a diagram schematically showing the Raman spectroscopic device 200 according to the present embodiment.

The Raman spectroscopic device 200 includes a gas sample holding section 110, a detection section 120, a control section 130, and a housing 140 for housing the detection section 120 and the control section 130 as shown in FIG. 10. The gas sample holding section 110 includes the electric field enhancement element according to the invention. Hereinafter, an example of including the electric field enhancement element 100 as the electric field enhancement element according to the invention will be explained.

The gas sample holding section 110 includes the electric field enhancement element 100, a cover 112 for covering the electric field enhancement element 100, a suction channel 114, and an exhaust channel 116. The detection section 120 includes a light source 210, lenses 122a, 122b, 122c, and 122d, a half mirror layer 124, and a photodetector 220. The control section 130 includes a detection control section 132 for processing a signal detected in the photodetector 220 to control the photodetector 220, and a power control section 134 for controlling electric power of the light source 210 and so on, and the magnetic field to be applied to the magnetooptic material layer 20 of the electric field enhancement element 100. Although not shown in the drawings, the Raman spectroscopic device 200 can also include a power supply for supplying the coils for applying the magnetic field to the magnetooptic material layer 20 with the electric power based on a signal from the power control section 134. As shown in FIG. 10, the control section 130 can electrically be connected to connection sections 136 for achieving connection to an external device.

In the Raman spectroscopic device 200, when a suction mechanism. 117 provided to the exhaust channel 116 is operated, a negative pressure is applied in the suction channel 114 and the exhaust channel 116, and the gas (fluid) sample including the target substance to be the detection object is suctioned through a suction port 113. The suction port 113 is provided with a dust filter 115, and relatively large dust, some water vapor, and so on can be removed. The suction channel 114 and the exhaust channel 116 communicate with the space (the flow channel) 50 of the electric field enhancement element 100. The gas sample passes through the suction channel 114, the flow channel 50, and the exhaust channel 116, and is then discharged through a discharge port 118. When the gas sample passes through the flow channel 50, the target substance adsorbs to the metal fine structures 32 of the electric field enhancement element 100.

The shapes of the suction channel 114 and the exhaust channel 116 are shapes for preventing the external light from entering the electric field enhancement element 100. Thus, since light other than the Raman scattering light and acting as noise is prevented from entering, the S/N ratio of the signal can be improved. The material constituting the channels 114, 116 is, for example, a material difficult to reflect light, or has a color difficult to reflect light.

The shapes of the suction channel 114 and the exhaust channel 116 are shapes for decreasing the fluid resistance with respect to the gas sample. Thus, the detection at high sensitivity becomes possible. For example, by changing the shapes of the channels 114, 116 to the smooth shapes by eliminating the corners as much as possible, retention of the gas sample in the corner sections can be eliminated. As the suction mechanism 117, there is used, for example, a fan motor or a pump having static pressure and air volume corresponding to the channel resistance.

In the Raman spectroscopic device 200, the light source 210 irradiates the electric field enhancement element 100 including the metal fine structures 32 to which the target substance adsorbs with light (e.g., a laser beam with the wavelength of 633 nm, the incident light i). As the light source 210, a semiconductor laser or a gas laser, for example, is used. The light emitted from the light source 210 is collected by the lens 122a, and then enters the electric field enhancement element 100 via the half mirror layer 124 and the lens 122b. The SERS light is emitted from the electric field enhancement element 100, and the SERS light reaches the photodetector 220 via the lens 122b, the half mirror layer 124, and the lenses 122c, 122d. Therefore, the photodetector 220 detects the light reflected by the electric field enhancement element 100. Since the SERS light includes the Rayleigh scattering light having the same wavelength as the wavelength of the incident light from the light source 210, it is also possible to remove the Rayleigh scattering light using a filter 126 of the photodetector 220. The light from which the Rayleigh scattering light has been removed is received by a light receiving element 128 as the Raman scattering light via a spectroscope 127 of the photodetector 220. As the light receiving element 128, a photo diode, for example, is used.

The spectroscope 127 of the photodetector 220 is formed of, for example, an etalon using the Fabry-Perot resonance, and can be made to have a variable pass frequency band. The Raman spectrum unique to the target substance can be obtained by the light receiving element 128 of the photodetector 220, and the Raman spectrum thus obtained and the data held previously are compared with each other for matching to thereby make it possible to detect the signal intensity of the target substance.

It should be noted that the Raman spectroscopic device 200 is not limited to the example described above as long as the Raman spectroscopic device includes the electric field enhancement element 100, the light source 210, and the photodetector 220, and is capable of making the electric field enhancement element 100 adsorb the target substance, and then obtaining the Raman scattering light.

Further, in the case of detecting the Rayleigh scattering light as in a Raman spectroscopy method according to the present embodiment described above, it is also possible for the Raman spectroscopic device 200 to separate the Rayleigh scattering light and the Raman scattering light using the spectroscope without including the filter 126.

In the Raman spectroscopic device 200, there is included the electric field enhancement element 100 capable of easily dealing with the variation in the plasmon resonance wavelength. Therefore, the intensity of the Raman scattering light can be increased. Therefore, it is possible for the Raman spectroscopic device 200 to have high detection sensitivity.

### 4. Electronic Apparatus

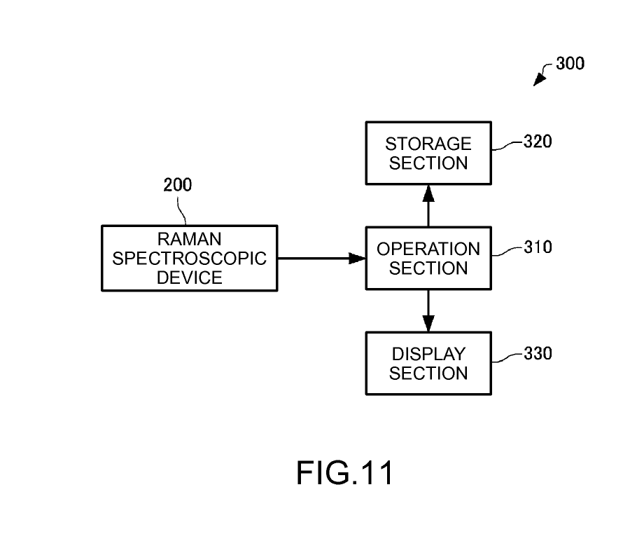

Then, an electronic apparatus 300 according to the present embodiment will be explained with reference to the accompanying drawings. FIG. 11 is a diagram schematically showing the electronic apparatus 300 according to the present embodiment. The electronic apparatus 300 can include the Raman spectroscopic device according to the invention. Hereinafter, an example of including the Raman spectroscopic device 200 as the Raman spectroscopic device according to the invention will be explained.

As shown in FIG. 11, the electronic apparatus 300 includes the Raman spectroscopic device 200, an operation section 310 for performing an operation on health medical information based on the detection information from the photodetector 220, a storage section 320 for storing the health medical information, and a display section 330 for displaying the health medical information.

The operation section 310 is, for example, a personal computer, a personal digital assistance (PDA), or a wearable terminal, and receives the detection information (e.g., a signal) transmitted from the photodetector 220. The operation section 310 performs the operation on the health medical information based on the detection information from the photodetector 220. The health medical information on which the operation has been performed is stored in the storage section 320.

The storage section 320 is, for example, a semiconductor memory or a hard disk drive, and can also be configured integrally with the operation section 310. The health medical information stored in the storage section 320 is transmitted to the display section 330.

The display section 330 is constituted by, for example, a display panel (e.g., a liquid crystal monitor), a printer, a light emitting body, and a speaker. The display section 330 displays or issues a notification based on, for example, the health medical information on which the operation has been performed by the operation section 310 so that the user can recognize the content of the information.

As the health medical information, there can be included information related to presence or absence, or an amount of at least one biologically-relevant substance selected from bacteria, a virus, a protein, a nucleic acid, and an antigen/antibody, or at least one compound selected from an inorganic molecule and an organic molecule.

In the electronic apparatus 300, there is included the Raman spectroscopic device 200 capable of easily dealing with the variation in the plasmon resonance wavelength. Therefore, according to the electronic apparatus 300, the detection of a trace substance can easily be achieved, and thus, the accurate health medical information can be provided.

The embodiments and the modified examples described above are illustrative only, and the invention is not limited to the embodiments and the modified examples. For example, it is also possible to arbitrarily combine the embodiments and the modified examples described above with each other. For example, the electric field enhancement element according to the invention can also be used as an affinity sensor for detecting presence or absence of adsorption of a substance such as presence or absence of adsorption of an antigen in an antigen-antibody reaction. By inputting white light to the affinity sensor, then the wavelength spectrum is measured by the spectroscope, and then detecting the shift amount of the surface plasmon resonance wavelength due to the adsorption, the affinity sensor can detect the absorption of the detection substance to the sensor chip at high sensitivity.

The invention includes configurations (e.g., configurations having the same function, the same way, and the same result, or configurations having the same object and the same advantage) substantially the same as the configuration described as the embodiment of the invention. Further, the invention includes configurations obtained by replacing a non-essential part of the configuration described as the embodiment of the invention. Further, the invention includes configurations exerting the same functions and advantages and configurations capable of achieving the same object as the configuration described as the embodiment of the invention. Further, the invention includes configurations obtained by adding known technologies to the configuration described as the embodiment of the invention.

The entire disclosure of Japanese Patent Application No. 2014-012126, filed Jan. 27, 2014 is expressly incorporated by reference herein.

What is claimed is:

1. An electric field enhancement element comprising:
a metal fine structure layer configured including a metal fine structure smaller in size than a wavelength of incident light;
a mirror layer adapted to reflect light having passed through the metal fine structure layer;
a magnetooptic material layer disposed between the metal fine structure layer and the mirror layer, and adapted to cause at least one of a Faraday effect and a Cotton-Mouton effect; and
a magnetic field generation device adapted to apply a magnetic field to the magnetooptic material layer.

2. The electric field enhancement element according to claim 1, wherein
the magnetic field generation device includes a coil.

3. The electric field enhancement element according to claim 1, wherein
the magnetic field generation device includes a permanent magnet.

4. The electric field enhancement element according to claim 1, further comprising:
a flow channel adapted to allow a sample including a target substance to have contact with the metal fine structure layer.

5. The electric field enhancement element according to claim 1, wherein
an application direction of a magnetic field to the magnetooptic material layer is one of a direction identical to an incident direction of the light to the magnetooptic material layer and a direction perpendicular to the incident direction.

6. The electric field enhancement element according to claim 1, wherein
the magnetooptic material layer has a garnet type crystal structure, and is expressed by a composition formula of R₃₋ₓBiₓFe_{5-y}A_{y}O₁₂,
in the composition formula, R represents at least one element selected from scandium (Sc), yttrium (Y), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu), Bi represents bismuth, Fe represents iron, A represents at least one element selected from gallium (Ga) and aluminum (Al), O represents oxygen, and x and y exist within the ranges of 0≦x<3 and 0≦y<5, respectively.

7. A Raman spectroscopic method analyzing a target substance, comprising:
adsorbing the target substance to the metal fine structure layer of the electric field enhancement element according to claim 1;
applying a magnetic field to the magnetooptic material layer, then applying the incident light from the metal fine structure layer side to detect light reflected by the electric field enhancement element, and then determining the magnetic field, with which reflectance in the electric field enhancement element becomes a local minimum; and
analyzing the target substance based on the light detected in a state of applying the magnetic field, with which the reflectance becomes the local minimum, to the magnetooptic material layer.

8. A Raman spectroscopic method analyzing a target substance, comprising:
adsorbing the target substance to the metal fine structure layer of the electric field enhancement element according to claim 2;
applying a magnetic field to the magnetooptic material layer, then applying the incident light from the metal fine structure layer side to detect light reflected by the electric field enhancement element, and then determining the magnetic field, with which reflectance in the electric field enhancement element becomes a local minimum; and
analyzing the target substance based on the light detected in a state of applying the magnetic field, with which the reflectance becomes the local minimum, to the magnetooptic material layer.

9. A Raman spectroscopic method analyzing a target substance, comprising:
adsorbing the target substance to the metal fine structure layer of the electric field enhancement element according to claim 3;
applying a magnetic field to the magnetooptic material layer, then applying the incident light from the metal fine structure layer side to detect light reflected by the electric field enhancement element, and then determining the magnetic field, with which reflectance in the electric field enhancement element becomes a local minimum; and
analyzing the target substance based on the light detected in a state of applying the magnetic field, with which the reflectance becomes the local minimum, to the magnetooptic material layer.

10. A Raman spectroscopic method analyzing a target substance, comprising:
adsorbing the target substance to the metal fine structure layer of the electric field enhancement element according to claim 4;
applying a magnetic field to the magnetooptic material layer, then applying the incident light from the metal fine structure layer side to detect light reflected by the electric field enhancement element, and then determining the magnetic field, with which reflectance in the electric field enhancement element becomes a local minimum; and
analyzing the target substance based on the light detected in a state of applying the magnetic field, with which the reflectance becomes the local minimum, to the magnetooptic material layer.

11. A Raman spectroscopic method analyzing a target substance, comprising:
adsorbing the target substance to the metal fine structure layer of the electric field enhancement element according to claim 5;
applying a magnetic field to the magnetooptic material layer, then applying the incident light from the metal fine structure layer side to detect light reflected by the electric field enhancement element, and then determining the magnetic field, with which reflectance in the electric field enhancement element becomes a local minimum; and
analyzing the target substance based on the light detected in a state of applying the magnetic field, with which the reflectance becomes the local minimum, to the magnetooptic material layer.

12. A Raman spectroscopic method analyzing a target substance, comprising:
adsorbing the target substance to the metal fine structure layer of the electric field enhancement element according to claim 6;
applying a magnetic field to the magnetooptic material layer, then applying the incident light from the metal fine structure layer side to detect light reflected by the electric field enhancement element, and then determining the magnetic field, with which reflectance in the electric field enhancement element becomes a local minimum; and
analyzing the target substance based on the light detected in a state of applying the magnetic field, with which the reflectance becomes the local minimum, to the magnetooptic material layer.

13. A Raman spectroscopic device analyzing a target substance, comprising:
the electric field enhancement element according to claim 1;
a light source adapted to irradiate the metal fine structure layer having the target substance adsorbed with the incident light; and
a photodetector adapted to detect light reflected by the electric field enhancement element.

14. A Raman spectroscopic device analyzing a target substance, comprising:
the electric field enhancement element according to claim 2;
a light source adapted to irradiate the metal fine structure layer having the target substance adsorbed with the incident light; and
a photodetector adapted to detect light reflected by the electric field enhancement element.

15. A Raman spectroscopic device analyzing a target substance, comprising:
the electric field enhancement element according to claim 3;
a light source adapted to irradiate the metal fine structure layer having the target substance adsorbed with the incident light; and
a photodetector adapted to detect light reflected by the electric field enhancement element.

16. A Raman spectroscopic device analyzing a target substance, comprising:
the electric field enhancement element according to claim 4;
a light source adapted to irradiate the metal fine structure layer having the target substance adsorbed with the incident light; and
a photodetector adapted to detect light reflected by the electric field enhancement element.

17. A Raman spectroscopic device analyzing a target substance, comprising:
the electric field enhancement element according to claim 5;
a light source adapted to irradiate the metal fine structure layer having the target substance adsorbed with the incident light; and
a photodetector adapted to detect light reflected by the electric field enhancement element.

18. A Raman spectroscopic device analyzing a target substance, comprising:
the electric field enhancement element according to claim 6;
a light source adapted to irradiate the metal fine structure layer having the target substance adsorbed with the incident light; and
a photodetector adapted to detect light reflected by the electric field enhancement element.

19. An electronic apparatus comprising:
the Raman spectroscopic device according to claim 13;
an operation section adapted to perform an operation on health medical information based on detection information from the photodetector;
a storage section adapted to store the health medical information; and
a display section adapted to display the health medical information.

20. The electronic apparatus according to claim 19, wherein
the health medical information includes information related to presence or absence, or an amount of at least one biologically-relevant substance selected from bacteria, a virus, a protein, a nucleic acid, and an antigen/antibody, or at least one compound selected from an inorganic molecule and an organic molecule.
